(19) United States
(12) Patent Application Publication
(10) Pub. No.: US 2005/0216277 A1
(43) Pub. Date: Sep. 29, 2005

(54) Map information system using identification code and method for producing the system

(76) Inventor: Seung-Chul Lee, Seoul (KR)

Correspondence Address: JONES DAY, 222 EAST 41ST ST, NEW YORK, NY, 10017, US

(21) Appl. No.: 10/514,058

(22) PCT Filed: Apr. 30, 2003
(86) PCT No.: PCT/KR03/00871

§ 371 Date: Nov. 8, 2004

(30) Foreign Application Priority Data
May 6, 2002 (KR) 10-2002-0024831

(51) Int. Cl. G06F 17/60

(52) U.S. Cl. 705/1

(57) ABSTRACT

Disclosed is a map information system including a server for providing map information expressing topography and buildings, and terminals connected to the server through network for receiving the map information, wherein the server includes a map information storing unit for storing identification codes endowed subsequently to certain partitions of the map at each enlargement stage, an extracting module for extracting corresponding map information when inputting the identification code to the server, and a transmitter for transmitting the extracted map information to the terminal, which also has a receiver for receiving the map information. Also disclosed is a method for producing the system, which includes: preparing a topographical map image; dividing the map image into several partitions and endowing serial numbers to the partitions for endowing the partitions with identification codes subsequently according to the enlargement stages; and dividing/storing each division of the map image.

### TECHNICAL FIELD

The present invention relates to a map information system using identification codes and a method for producing the system, and more particularly to a map information system using the Flash animation in which an identification code is endowed to each map information such as topography and building for the purpose of easy search through Internet and its producing method.

### BACKGROUND ART

The term “map information” used in this specification is defined to include not only a map but also all kinds of infonnation based on the map such as topography, a building, many stores in one large-scale building and houses.

Thus, the map information system is also defined as a system for providing all kinds of information based on the map such as topography, a building, many stores in one large-scale building and houses in addition to the map to a user in need through Internet.

Furthermore, the term “map” used in this specification is defined to include a picture showing a virtual space as well as a picture showing a real space.

Currently, all information in Internet is classified using keywords and categories on the basis on text, and this information is all connected according to its domain address.

For example, in order to connect to ‘Lotte Department Store’ located in 11, Sogong-dong, Jung-gu, Seoul in South Korea, a user firstly searches “Lotte Department Store” as a keyword in any search engine, and then if information including the text “Lotte Department Store” is searched, the user clicks a desired branch shop of “Lotte Department Store”. In other case, the user may use a category I which various information is classified according to the category, for example in an order of ‘shopping’→‘department store’→Lotte department store→Lotte department store located at Jung-gu in Seoul. Or else, the user may also connect there by inputting a domain name of “Lotte Department Store” ‘http://www.lotte.com’.

These methods are very useful when the user does not know a road to reach the store or a location of the store. However, if the user only remembers the location of the store, those methods may be a complicated one to find out a road reaching the store or the location of the store.

In addition, the existing map information system provided currently in Internet firstly removes the map information related to the existing location and then loads another map information of the location to be moved when moving from the current position to another position by dragging or clicking. This causes cutoff or blinking of the picture due to instantaneous movement while the new map information is loaded, so making the user inconvenient or difficult in checking the map information.

### DISCLOSURE OF INVENTION

The present invention is designed to solve the problems of the prior art, and therefore an object of the invention is to provide a map information system in which various movies such as map source movies industrial classification movie and building access movies are provided by use of Flash animation, and a specific identification code is endowed to each map information for the purpose of useful searching, and a method for producing the system.

In addition, another object of the invention is to provide a method for producing a map information system which has no picture cutoff during movement by use of a duplicated level.

In this aspect, the present invention provides a system which ensures a user to access an electronic commerce system by clicking a desired store or directly inputting a corresponding identification code on an enlarged map of a desired location so that the user may easily and conveniently access a desired store without use of a hardly-memorized domain name or complicated searching process.

In addition, the present invention also provides a map information system which shows natural movement of picture without cutoff by loading new map information in a level different from the existing map information, without removing the map information related to the present location.

In order to accomplish the above object, the present invention provides a map information system including a server for providing map information to be expressed on a map, and a terminal connected to the server through a network to receive the map information, wherein the server includes a map information storage unit for storing identification codes which are subsequently endowed to partitions of the map in each enlargement stage; an extracting module for extracting corresponding map information when the identification code is input to the server from the terminal; and a transmission means for transmitting the extracted map information to the terminal, wherein the terminal includes receiving means for receiving the requested information from the server.

In another aspect of the invention, there is also provided a method for producing a map information system having a storing unit for storing a map image, which includes the steps of: preparing a map image including topography; dividing the map image into several partitions, endowing serial numbers to the partitions from the left upper one, and marking the serial numbers to each partition of the map image according to an enlargement stage of the map image to define identification codes; diagonally dividing and storing the partitions of the map image; and making and storing movement movies by associating the stored partitions of the map image.

This method may further include the step of: making a movement movie for movement between all possible menu buttons, and endowing the movement movie with a level value different from the level value of the existing map so that the movement movie is loaded in a different level from the existing map.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows a map information system using identification codes according to a preferred embodiment of the present invention;

FIG. 2 is a block diagram schematically showing a server used in the map information system according to a preferred embodiment of the present invention;

FIG. 3a is a flowchart for illustrating the process of producing a map image movie according to a preferred embodiment of the present invention;

FIG. 3b is for illustrating the process of endowing an identification code to a map image according to a preferred embodiment of the present invention;

FIG. 3c is for illustrating the method for dividing the map image according to a preferred embodiment of the present invention;

FIG. 3d shows the state of the divided map image which is composed and output on a screen according to a preferred embodiment of the present invention;

FIG. 3e is for illustrating the movement of picture according to a preferred embodiment of the present invention;

FIGS. 3f and 3g show an example for making a movie moving left according to a preferred embodiment of the present invention;

FIGS. 3h and 3i show an example for making a move moving diagonally according to a preferred embodiment of the present invention;

FIGS. 3j and 3k show an example for making movement movies having different levels according to a preferred embodiment of the present invention;

FIG. 4a is a flowchart for illustrating the process of making an industrial classification movie according to a preferred embodiment of the present invention;

FIG. 4b exemplarily shows identification codes in the industrial classification according to an upper level menu and a lower level menu;

FIG. 5 is a flowchart for illustrating the process of making a store access movie according to a preferred embodiment of the present invention; and

FIGS. 6a to 6d show examples of web categories according to a preferred embodiment of the present invention.

### BEST MODES FOR CARRYING OUT THE INVENTION

Hereinafter, preferred embodiments of the present invention will be described in detail with reference to the accompanying drawings.

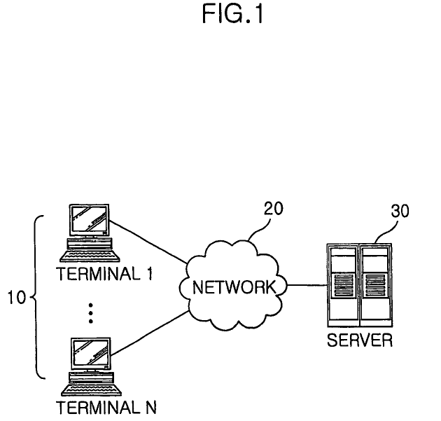

FIG. 1 shows a system configuration for realizing a map information viewing method using identification codes according to a preferred embodiment of the present invention. As shown in FIG. 1, the map information system of the present invention includes at least one terminal 10 and a server 30, which are connected through a network 20.

The terminal 10 may be PDA, IMT2000, cellular phone, personal computer, workstation or other computer system larger or smaller than them. The terminal 10 typically includes one or more processor, memory and I/O device.

The server 30 also has a similar configuration to the terminal. However, the server 30 may include a plurality of computers connected through a local network. In fact, the network may include hundreds or thousands of individual computer networks.

The network 20 may use Internet communication protocol (IP) which allows communication between the terminal and the server. Internet is representatively designated as the network 20, but it should be understood that the network may include Intranet, Extranet and Private Network, not limitedly.

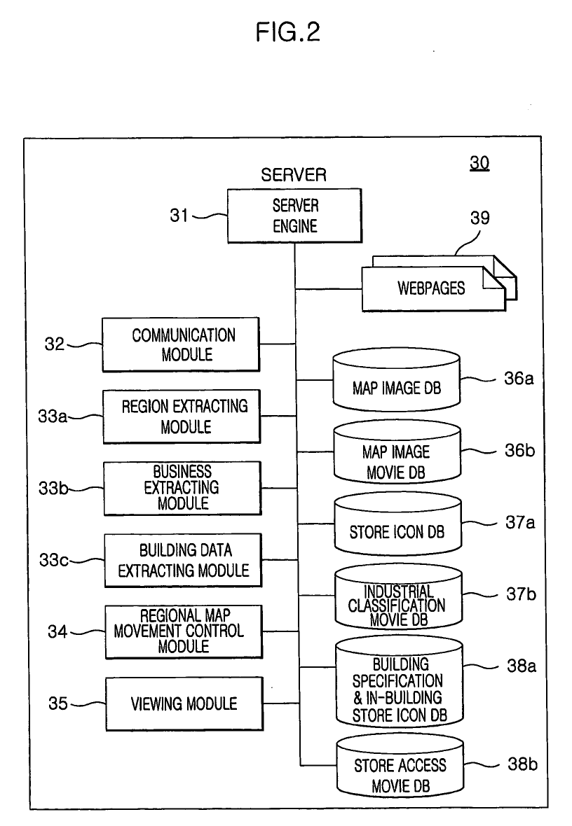

FIG. 2 shows program modules loaded in ROM of the server 30 and a plurality of databases composing a data storage device. Now, various program modules and databases equipped in the server 30 are described in detail with reference to FIG. 2.

The server 30 includes program modules such as a server engine 31, a communication module 32 for data transmission, a region extracting module 33a, a business extracting module 33b, a building data extracting module 33c, a regional map movement control module 34 and a viewing module 35; and a database system composed of a map image DB 36a, a map image movie DB 36b, a store icon DB 37a, an industrial classification movie DB 37b, a building specification & in-building store icon DB 38a and a store access movie DB 38b.

Here, the server engine 31 is in charge of system operation. In particular, the server engine 31 is a firmware program for providing a web page 39 to a client system, or the terminal 10, on the HTTP (Hyper Text Transfer Protocol) request for accessing the web page 39 identified by URL (Uniform Resource Locator).

The region extracting module 33a plays a role of extracting a corresponding location code map when a location code is input from the terminal 10.

The regional map movement control module 34 acts for extracting a corresponding movie when a map enlargement, contraction or movement command is input from the terminal 10.

The business extracting module 33b plays an act of extracting a corresponding business movie when a business is selected by the terminal 10.

The building data extracting module 33c plays a role of extracting a movie including a sectional view of each story of a corresponding building and store icons when a building code is input from the terminal 10.

The viewing module 35 is used for loading a movie. When a movement command is input from the terminal 10, the viewing module 35 loads a new movie to be moved in a level different from the existing movie, and then removes the existing movie in the second frame at which the movement animation starts in order to prevent the movement movie from being hidden by the map in the existing level. If the movement is completed, the viewing module 35 displays buttons and information related to the corresponding locations.

The map image DB 36a is a database for storing images of regional maps. The map image movie DB 36b is a database for storing movies used for the movement of regional maps.

In addition, the store icon DB 37a is a database for storing store icons which are output on an industrial classification picture, and the industrial classification movie DB 37b is a database for storing movies positioned according to actual locations of the industrially-classified stores and their movement movies.

The building specification & in-building store icon DB 38a is a database for storing an interior structure (or, a sectional view for each story) and store icons of a building which is displayed on the screen when inputting a building code. The store access movie DB 38b is a database for storing movies made using the sectional view of each story and the store icons, and movement movies.

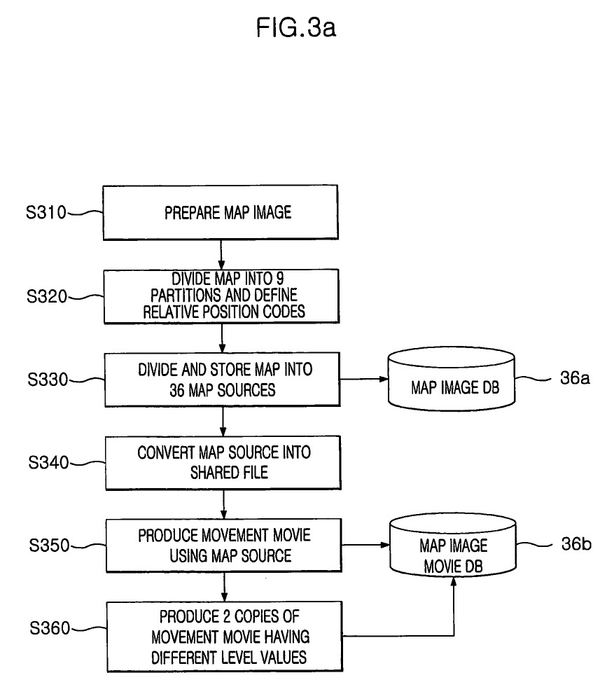

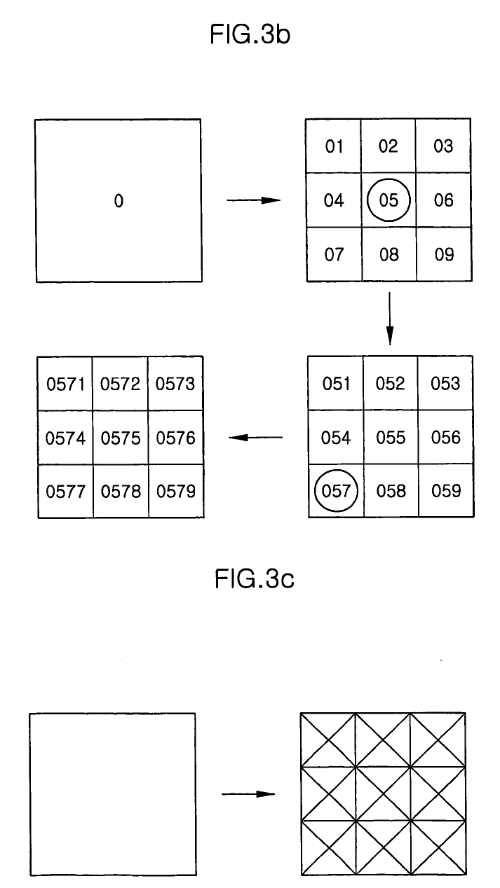

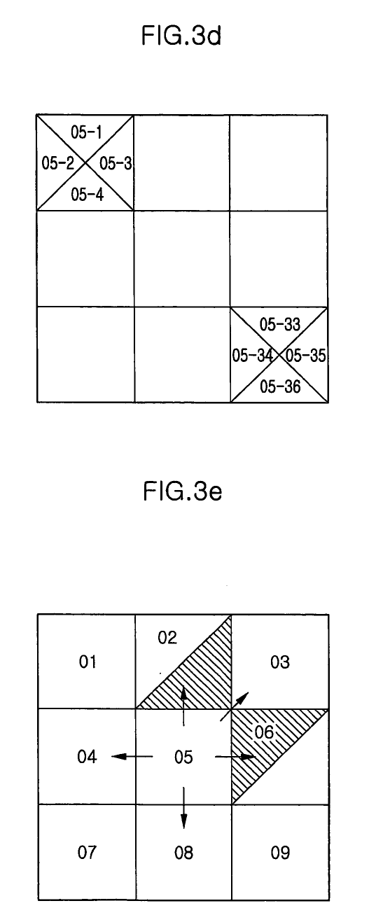

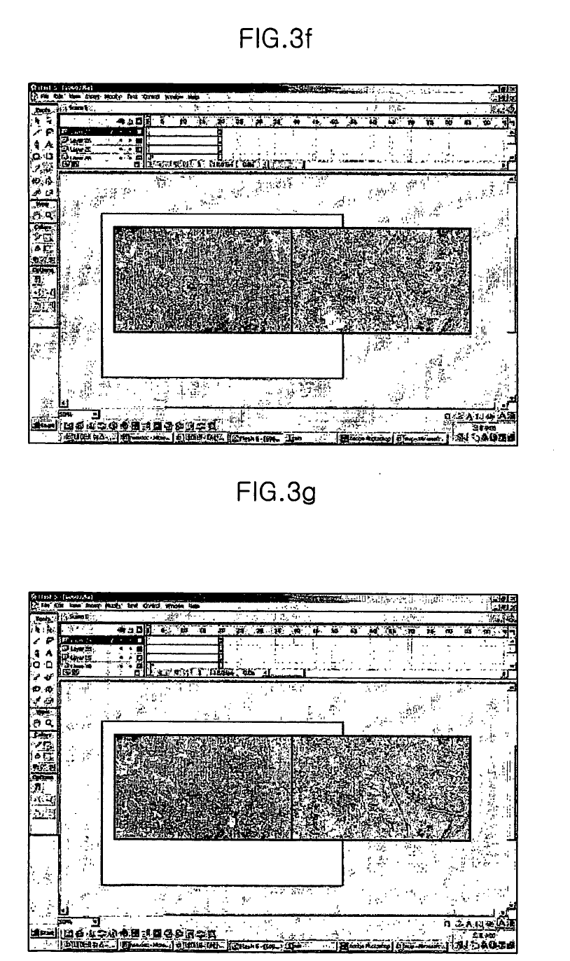

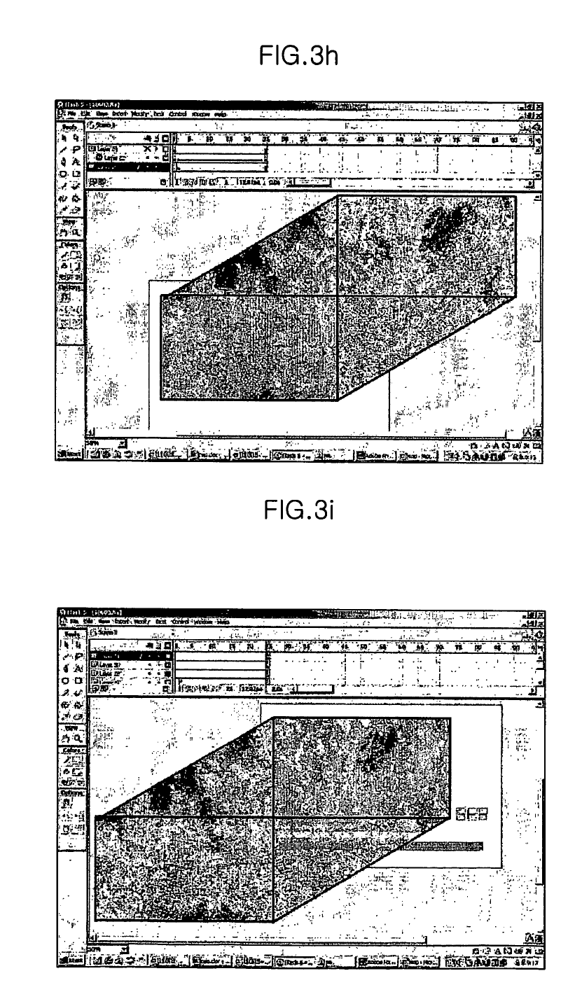

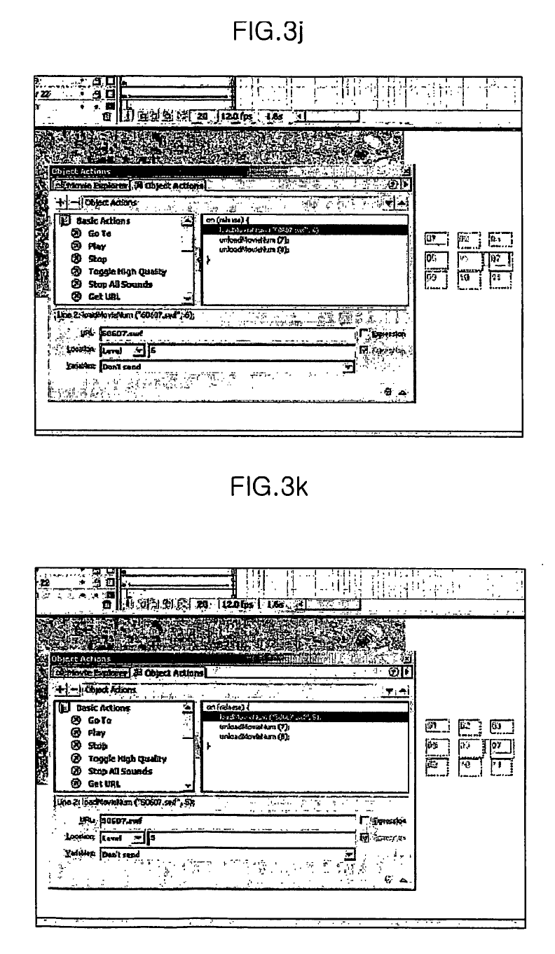

Now, the process for producing map information using the identification codes realized by the above-mentioned system according to the present invention is described with reference to FIGS. 3 to 6.

At first, a map image corresponding to the actual map is prepared (S310). The map image may be directly drawn using Flash, or made using a printed image or picture.

Flash is software developed by Macromedia. This software is generally used for making vector-based animation accompanying whole screen interface, graphic illustration and simple interactions. Flash makes an animation file which is so small to be streamed through the modem, and this file is capable of anti-aliasing as well as enlargement or contraction on the screen. Currently, this software is commercially used up to V6.0, and there are easily found many animation files made using the software in various web sites owing to the benefit of rapidness and smooth graphic expression. The contents made by Flash is stored with a file extension name “.swf”.

A starting map may be a national map (e.g., Korean map) or a city map (e.g., Seoul map), and there are preferably provided gradually subdivided maps like the starting map, a first enlargement map, a second enlargement map, a third enlargement map and so on, in a basic rectangular screen to be seen in a web browser.

The prepared map in a screen is divided into the predetermined number of partitions to which relative position codes are endowed (S320).

Preferably, the numbers 1˜9 are endowed to the partitions subsequently from the left top to the right bottom, and this numbers are marked after the map code, which is already endowed to the map on the screen, to make the relative position code.

Though it is described as an example that numbers are endowed to the partitions, the numbers may be replaced with Alphabet or Korean literature.

For example, as shown in FIG. 3b, if the starting map endowed with a code 0 is divided into 9 partitions endowed with position codes 01˜09 and the map image corresponding to the position code 05 is again divided into 9 partitions, the partitions of the map image having the position code 05 are endowed with position codes 051˜059.

If the map image corresponding to the position code 057 is again divided into partitions, these partitions are endowed with position codes 0571˜0579.

This position code becomes an identification code for identifying the corresponding map image.

The map image prepared as above is for example divided into 9 blocks and then the 9 blocks are diagonally divided into 36 pieces when stored (S330).

In other words, one map image of this embodiment is divided into 36 pieces and then stored for the purpose of enabling a fme movement of the map. The present invention is not limited to the case of 36 pieces, it is also possible to store 4 pieces by dividing the map image only diagonally without dividing into 9 blocks, or to store 16 pieces by dividing the map image into 4 blocks and then diagonally dividing the blocks into 16 pieces.

The diagonal division is very helpful for lessening the burden generated when moving one map image into another map image in a diagonal direction.

Each piece may have a certain mark so that a user may understand a position code belonging to the piece and the sequence of each piece. For example, as shown in FIG. 3d, the piece may be expressed in file name format ‘position code_sequence of piece’, for example 051_1 or 051_2. In case the pieces are stored in a table, the table may have data having the sequence of each piece.

The map image stored as above is converted into a map-sharing data movie by importing it into Flash and then inputting an image sharing function (S340). Thus, by using the map-sharing data movie, the movies for outputting on the screen, moving, enlarging or contracting are respectively made (S350).

Here, the step S340 is not essential, and the map image may be used just in a shared state.

The reason of sharing the map image is that the map once loaded may be used again without an additional loading process.

For example, in order to output the map image having a position code 05 on the screen, there may be generated a movie corresponding to the position code 05 by associating and publishing all of the map-sharing data movies having the position codes from 05_1 to 05_36, as shown in FIG. 3d.

The publishing helps to safely insert a Flash movie into an HTML document In other words, since the basic document format of Internet is HTML, a certain code (e.g., Object tag or Embed tag) is inserted into the HTML document for connection of the Flash movie, not directly linking the Flash movie. Of course, the Flash movie may be used when linking .swf document directly, not inserting the code in the HTML document.

In addition, as shown in FIG. 3e, the file name is determined so that a movement movie moving left is 0504, a movement movie moving right is 0506, a movement movie moving upward is 0502, a movement movie moving downward is 0508, and then the species are associated for publishing. For example, as in FIGS. 3f and 3g, in case of the 0506 file, a user selects user the automatic animation function after setting the map 05 in the first frame and the map 06 in the last frame.

In case of moving diagonally, the movie requires further spice images positioned at the side and the top of the first frame, which are to be seen during the movement, in addition to the first and last frames. For example, in case of moving from the map 05 to the map 03, the spice images of the areas expressed by slant lines in FIG. 3e are further associated.

FIGS. 3h and 3i show examples of producing diagonally moving movies.

In addition to the production of the movie corresponding to 8 directions, the movies for enlargement and contraction are also produced using the automatic animation function.

Such movement of movie is not limited to 8-directional movement, enlargement and contraction, 16-directional movement for finer movement or multistage movement for example from an image map 0501 to an image map 0601 is also possible. In addition, other various movies may be also made depending on moving direction, moving distance or moving speed.

When moving the movement movie, a masking technique provided in Flash software is preferably used so that the movement is seen only in an area output on the screen and other areas are hidden by the mask.

For example, since the movement movie moving from the map 05 to the map 06 is made by associating the map 05 and the map 06, the map 05 and the map 06 are all seen when this movement movie is loaded. However, when the movement movie starts moving, the maps may be seen out of a map frame in the screen. Thus, in order to show the movement of the map accurately inside the map frame, a mask layer using the map moving animation is applied so that the movement movie is seen only inside the map frame, but the mask hides other areas out of the map frame.

In the above masking technique, there is made a rectangular frame having a black color in one layer so that the frame has a size matching with the screen, and then only the inner area of the black rectangular frame is seen and other areas are all hidden and not seen by the user.

The masking technique is not essential to the present invention, but it may give natural and smooth picture in the aspect of user interface.

Here, the 10 movies related to movement are configured doubly in order to solve the cutoff or blinking of the map during movement. In other words, there are made two movement movies having different levels to each movement button so that the movement movies may be cross-linked (S360).

In more detail, two identical copies of a map are made in different levels in order to configure a duplicated map. Thus, the drawback of the prior art that the movement movie is loaded in a level different from the existing map, and after it is completely loaded the existing movie is removed at the second frame where the movement animation starts so that the movement movie is hidden by the existing map in the former level may be prevented.

Though it is described that the movement map is made in two levels, the movement map may be made in three or more levels in order to eliminate the cutoff or blinking of the map during movement, not limited to the above case.

For example, FIGS. 3j and 3k show that 6 or 5 levels are applied to make the movement movie moving from the map 06 to the map 07.

If the movement movie current seen in the screen is a movie moving from the map 07 to the map 06, a script for loading the movement movie 0607 in 5 and 6 levels respectively is set on the movement button for moving to the map 07 so that the map 07 is again moved to the map 06.

If the movement movie current seen on the screen is a movie loaded in the 5 level, a script for loading the movement movie 60607.swf in the 6 level is set to the movement button for movement to the map 07 as shown in FIG. 3j in order to load the movie moving to the map 07 in the 6 level, and then existing movie is stored in the name of 50706.swf.

In addition, if the movement movie current seen on the screen is a movie loaded in the 6 level, a script for loading the movement movie 50607.swf in the 5 level is set to the movement button for movement to the map 07 as shown in FIG. 3k in order to load the movie moving to the map 07 in the 5 level, and then existing movie is stored in the name of 60706.swf If the movie 50706.swf is current seen on the screen and the movement button for moving to the map 07 is clicked, the movie 60607.swf for moving from the map 06 to the map 07 is loaded in the 6 level, not in the current 5 level, and then if clicking the movement button for moving to the map 06 after moving to the map 07, the movie 50706.swf is loaded in the 5 level, not the current 6 level, so that the movies may be cross-linked.

If the movie 60706.swf is current seen on the screen and the movement button for moving to the map 07 is clicked, the movie 50607.swf for moving from the map 06 to the map 07 is loaded in the 5 level, not in the current 6 level, and then if clicking the movement button for moving to the map 06 after moving to the map 07, the movie 60706.swf is loaded in the 6 level, not the current 5 level, so that the movies may be cross-linked.

Since each movement movie is produced on the movement button of the map so that it may be loaded in two levels, the movement movies of all maps may be cross-linked to each other. Thus, the existing map is kept to output information continuously while new information selected by a user is loaded, and then the existing movie is removed at the second frame of the movement animation when the new information is completely loaded, thereby preventing the map from being hidden. In addition, various information on the map at a moved position is loaded in the new position together with net movement buttons when the movement is completed, so the movement, enlargement and contraction may be smoothly made and the cutoff or blinking of the map is eliminated.

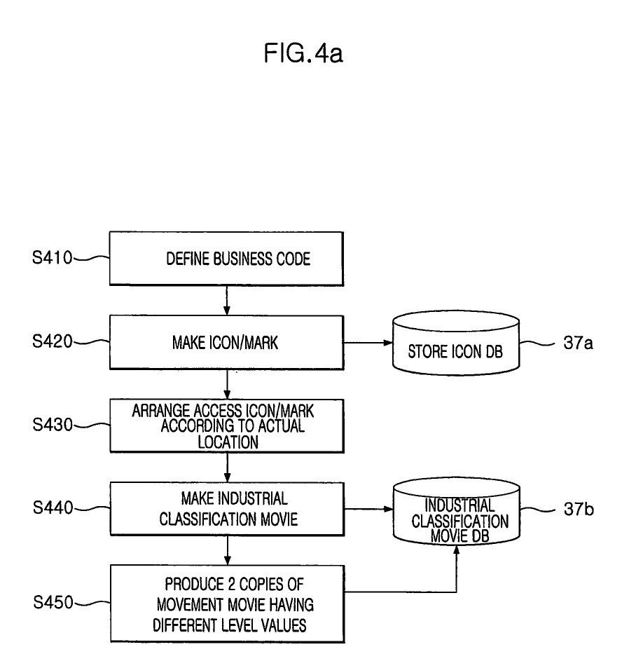

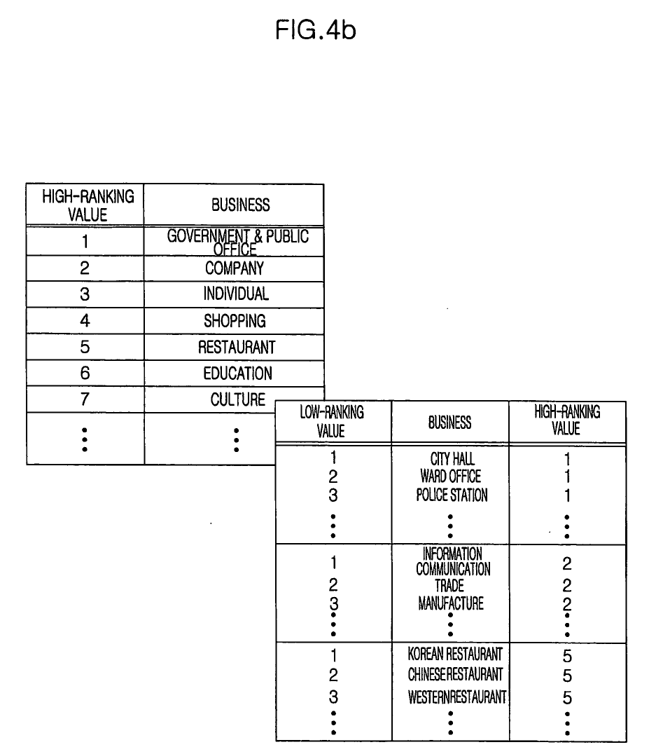

Now, the process of producing an industrial classification movie according to a preferred embodiment of the present invention is described with reference to FIG. 4a.

At first, classification items of all organizations, companies, stores and individuals are designated and classified in high-ranking menus and low-ranking menus. Then, the high-ranking menus and the low-ranking menus are respectively endowed with certain values, and then the values are marked in the order of the high-ranking menu and the low-ranking menu to make the business codes (S410).

For example, a Chinese restaurant has a business code 52, which is made by subsequently marking a high-ranking menu value 5 of the restaurant and a low-ranking menu value 2 of the Chinese restaurant. In the same way, a police station is endowed with a business code 13, made by marking a high-ranking menu value 1 of the government and public office and a low-ranking menu value 3 of the police station in order.

Here, the menu of the industrial classification is not limited in two stages, but more than 2 stages may be used in the menu structure for detailed classification and searching if the menu values are marked in order of the stages.

In addition, it is also possible that the low-ranking menu value itself includes the high-ranking menu value.

After defining the business codes, an access icon or mark is made for each store (S420). The access icons or marks of each store are arranged according to the business code in the actual location of the store in all areas (S430). After that, an industrial classification movie is also made in each corresponding location so that the access icons or marks arranged according to the industrial classification may be loaded when a user selects the corresponding menu (S440).

By using the above industrial classification movie, the movie used in movement between menus is doubly made to have different two level values in order to make the duplicated map structure for solving the cutoff or blinking problem of the map (S450).

In other words, two identical copies of a map are made in different levels in order to configure a duplicated map. Thus, the drawback of the prior art that the movement movie is loaded in a level different from the existing map, and after it is completely loaded the existing movie is removed at the second frame where the movement animation starts so that the movement movie is hidden by the existing map in the former level may be prevented.

Though it is described that the movement map is made in two levels, the movement map may be made in three or more levels in order to eliminate the cutoff or blinking of the map during movement, not limited to the above case.

In addition, the menu button is programmed so that movement movies corresponding to all possible movements having a different level may be loaded on each movement movie.

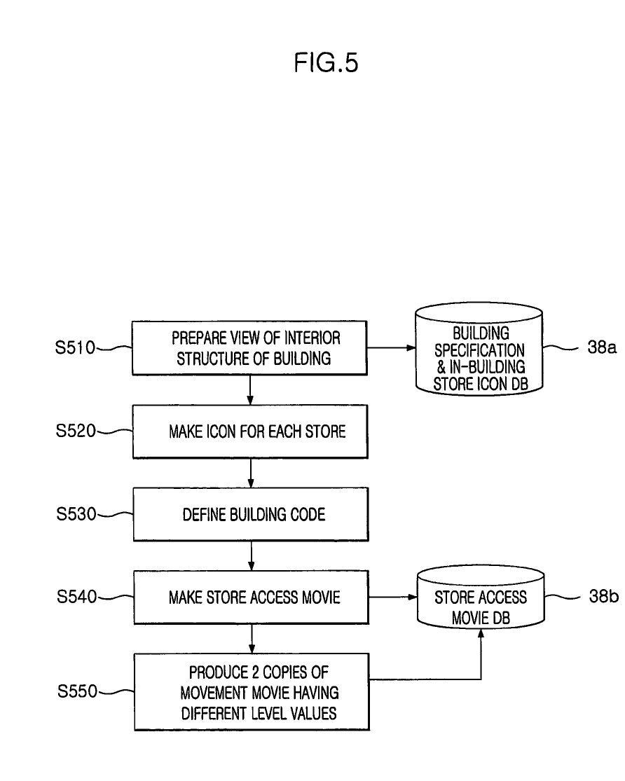

Now, the process of producing a store access movie according to a preferred embodiment of the present invention is described with reference to FIG. 5.

In case of a building such as a shopping mall to which many stores are belonged, an image showing an interior structure such as a sectional view of each story is prepared so that a user may easily access the stores in the building (S510). In addition, information of each store such as homepage or an access icon for accessing an electronic system is made (S520).

Though this embodiment is described using the shopping mall as an example, the present invention is not limited to that case, but any building in which many occupants exist in individual spaces such as department store, apartment, residence hall and hostel may be included.

An identification code is endowed to the building, and each occupant is endowed with a specific code (S530).

Preferably, the identification codes may be endowed according to the kind of buildings such as department store, apartment, residence hall or hostel. The identification code is preferably made using numbers, but not limited to that case, Alphabet or Korean literature may be also used.

The store access icons for the stores belonging to a story is arranged on a sectional view of the corresponding story, and then the sectional view of each story is made into movies and then stored (S540).

By using the above-mentioned store access movie, the movie used for movement between stories is doubly made to have different two level values in order to make the duplicated map structure for solving the cutoff or blinking problem of the map (S550).

In other words, two identical copies of a map are made in different levels in order to configure a duplicated map. Thus, the drawback of the prior art that the movement movie is loaded in a level different from the existing map, and after it is completely loaded the existing movie is removed at the second frame where the movement animation starts so that the movement movie is hidden by the existing map in the former level may be prevented.

Though it is described that the movement map is made in two levels, the movement map may be made in three or more levels in order to eliminate the cutoff or blinking of the map during movement, not limited to the above case.

As described above, the map information system using the identification codes which are endowed to certain regions of the map in each enlargement stage may be useful for finding out a position not only in the actual map but also in the virtual space.

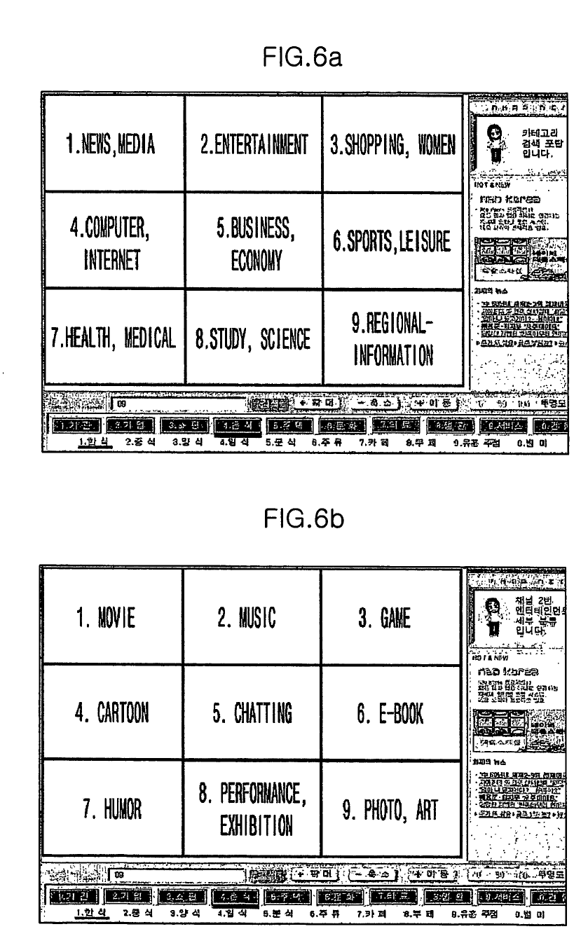

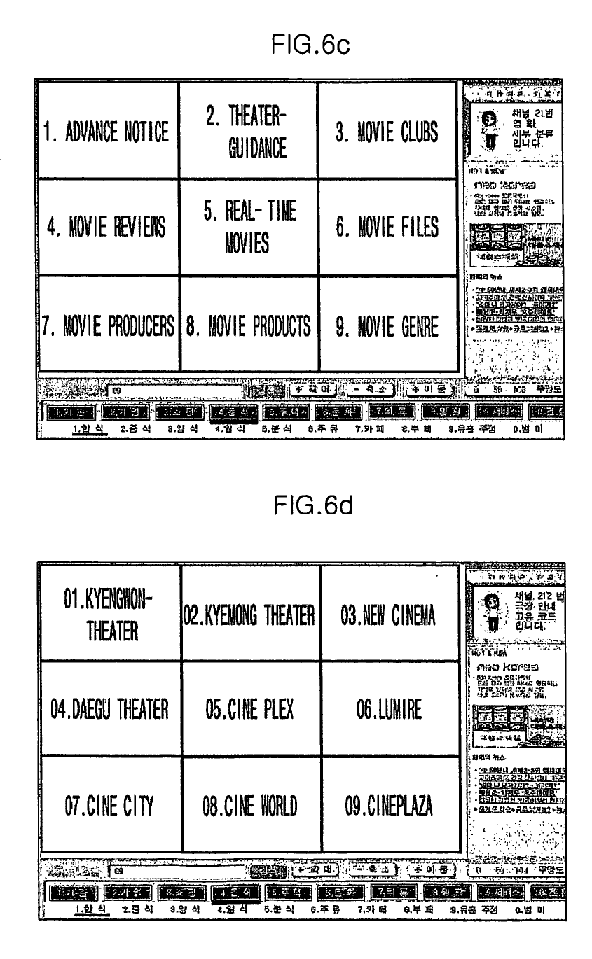

As shown in FIG. 6a, various categories are classified in a virtual space so that the main classifications are positioned in 9 areas. These main classifications are endowed with identification codes 1˜9.

If clicking the category ‘entertainment’ having the identification code 2 or selecting the category by inputting the number 2 in an input section, the subcategories of the main category are output on the screen as shown in FIG. 6b.

If clicking the subcategory ‘movie’ having the identification code 1 or selecting the subcategory by inputting the number 21 in the input section, the sub-categories of the corresponding category are output on the screen as shown in FIG. 6c.

If clicking the subcategory ‘theater guidance’ having the identification code 2 or selecting the subcategory by inputting the number 212 in the input section, the sub-categories of the corresponding category are output on the screen as shown in FIG. 6d, and the user may select a desired theater in the screen.

In other words, the user may access ‘Cine City’ by several clicks following the above procedure, but it is also possible to input the identification code ‘21207’ in the input section to access ‘Cine City’.

Such a system for providing map information of the virtual space with the use of identification codes is produced by defining identification codes and then making movement movies using the same way as the former embodiment.

In other words, two identical copies of a map are made in different levels in order to configure a duplicated map. Thus, the drawback of the prior art that the movement movie is loaded in a level different from the existing map, and after it is completely loaded the existing movie is removed at the second frame where the movement animation starts so that the movement movie is hidden by the existing map in the former level may be prevented.

In addition, the menu button is programmed so that movement movies corresponding to all possible movements having a different level may be loaded on each movement movie, similar to the case of making the map source movie.

On the other hand, the building mentioned in the steps S510˜550 is not limited to stores such as shopping mall, it may be applied to non-business buildings such as apartment or dwelling house purposed of residence. In this case, it is possible to connect a user to a home networking system or a digital device of the house or a homepage of the dweller by using such as a house lot number, instead of the electronic commerce site of the store.

### INDUSTRIAL APPLICABILITY

The map information system constructed as above according to the present invention enables a user to easily search a spot, a building or a store by use of the corresponding identification code.

In addition, the map provided by the system of the present invention may be freely moved, enlarged or contracted without the cutoff or blinking problem of the map.

Moreover, the present invention provides convenient industrial classification menus and marks all access icons in their accurate positions on the map, and thereby the present invention may construct an integrated operation system which provides various life information together with geographical information.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A map information system including a server for providing map information to be expressed on a map, and a terminal connected to the server through a network to receive the map information, wherein the server comprises:
map information storage means for storing identification codes which are subsequently endowed to partitions of the map in each enlargement stage;
an extracting module for extracting corresponding map information when the identification code is input to the server from the terminal; and
a transmission means for transmitting the extracted map information to the terminal,
wherein the terminal includes receiving means for receiving the requested information from the server.

2. A map information system according to claim 1, wherein the map information is topography.

3. A map information system according to claim 2,
wherein the topography is divided into 9 partitions, which are endowed with serial numbers subsequently from the left upper partition, and the serial numbers are subsequently marked on the map according to the enlargement stage of the map.

4. A map information system according to claim 3,
wherein the map information further includes an industrial classification movie having an identification code in which values determined in a high-ranking menu and a low-ranking menu are subsequently marked.

5. A map information system according to claim 4,
wherein the identification code is made by subsequently marking a specific code for industrial classification, in which the values determined in the high-ranking menu and the low-ranking menu are subsequently marked, and a specific code for a store.

6. A map information system according to claim 3,
wherein the map information further includes a building access movie in which a building code endowed to a building and a number corresponding to a story of the building are subsequently marked.

7. A map information system according to claim 6,
wherein the identification code is made by subsequently marking a building code endowed to a building and a store code endowed to a store in the building.

8. A method for producing a map information system having a storing unit for storing a map image, comprising the steps of:
preparing a map image including topography;
dividing the map image into several partitions, endowing serial numbers to the partitions from the left upper one, and marking the serial numbers to each partition of the map image according to an enlargement stage of the map image to define identification codes;
diagonally dividing and storing the partitions of the map image; and
making and storing movement movies by associating the stored partitions of the map image.

9. A method for producing a map information system according to claim 8,
wherein the map image is divided into 9 partitions, and the 9 partitions of the map image are divided into 36 pieces.

10. A method for producing a map information system according to claim 8, further comprising the steps of:
making an icon and/or a mark for each store;
defining an identification code for each industrial classification movie by subsequently marking predetermined values defined in a high-ranking menu and a low-ranking menu;
making and storing the industrial classification movie by arranging the icon and/or mark at a corresponding location of the store; and
making and storing movement movies for movement between all possible businesses.

11. A method for producing a map information system according to claim 10, further comprising the steps of:
preparing a sectional view showing interior structure of a building;
making an icon for each store in the building;
defining an identification code by subsequently marking a building code endowed to the building and a story code endowed to each story of the building;
arranging and storing the icon at a corresponding position of the store in the sectional view of the building for each story; and
making and storing movement movies for movement between the all possible stories.

12. A method for producing a map information system according to claim 8, further comprising the step of:
making a movement movie for moving from a map image corresponding to a certain location code to another map image corresponding to a different location code, and endowing the movement movie with a level value different from the level value of the existing map so that the movement movie is loaded in a different level from the existing map.

13. A method for producing a map information system according to claim 10 or 11, further comprising the step of:
making a movement movie for movement between all possible menu buttons, and endowing the movement movie with a level value different from the level value of the existing map so that the movement movie is loaded in a different level from the existing map.
